(19) United States
(12) Patent Application Publication
(10) Pub. No.: US 2010/0123644 A1
(43) Pub. Date: May 20, 2010

(54) APPARATUS INCORPORATING AN ELECTRONIC DISPLAY

(75) Inventors: Karl-Heinz Mueller, Hong Kong (CN); Kitty Lo, Hong Kong (CN); Dino Lalvani, Hong Kong (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Binatone Electronics International Ltd., Hong Kong (CN)

(21) Appl. No.: 12/327,544

(22) Filed: Dec. 3, 2008

(30) Foreign Application Priority Data
Nov. 18, 2008 (GB) 0821052.8

(51) Int. Cl. G09G 5/00

(52) U.S. Cl. 345/1.1

(57) ABSTRACT

Apparatus comprises an electronic display, a processor coupled to the electronic display and configured by software to divide the electronic display into first and second display portions, a frame member including at least two surround members and a divider member. The frame member is secured adjacent the electronic display so that the surround members provide a surround to at least two opposite edges of the electronic display and such that the first display portion of the electronic display is on an opposite side of the divider member to the second display portion of the electronic display, and wherein the processor is configured by software to control the display to provide a first image in the first display portion and a second image in the second display portion, the second image being independent of the first image.

### FIELD

This invention relates to apparatus comprising an electronic display, a processor and a frame member.

### BACKGROUND

Digital photograph frames are well-known. They typically comprise a colour liquid crystal display (LCD) and a memory card module. By providing files representing digital photographs on a memory card and inserting the card into the digital photograph frame, a user can obtain display of their digital photographs on a device having the appearance of a conventional photograph frame. Users often like the ability to change the digital photograph being displayed by simple manipulation of a control on the digital photograph frame, compared to the laborious manual replacement process that is required with conventional photograph frames. Users often like also the ability that is present in some digital photograph frames to cycle through a number of different photographs in a slideshow effect.

It is known for digital photograph frames to be controllable to divide a display into four fields and to display different digital photographs in the different fields. The effect is not unlike that obtained in split screen video systems, such as those found in security camera monitoring stations.

Digital photograph frames are relatively expensive. A significant part of the cost is made up of the costs of the display. Displays having an aspect ratio of 16:9 tend to be less costly than displays of other aspect ratios for a given size. However, digital photographs typically have an aspect ratio of 4:3. As such, digital photograph frames tend to use more costly 4:3 displays or alternatively utilise image cropping, blank borders and/or stretching in order to accommodate photographs on a display having a different aspect ratio. These techniques are undesirable in that they can reduce the effectiveness of the digital photograph frame and because it can involve a cost in order to provide a digital photograph frame with the ability to apply the techniques.

The invention was made in this context.

### SUMMARY

According to the present invention, there is provided apparatus comprising:
an electronic display;
a processor coupled to the electronic display and configured by software to divide the electronic display into first and second display portions; and
a frame member including at least two surround members and a divider member,
   wherein the frame member is secured adjacent the electronic display so that the surround members provide a surround to at least two opposite edges of the electronic display and such that the first display portion of the electronic display is on an opposite side of the divider member to the second display portion of the electronic display, and wherein the processor is configured by software to control the display to provide a first image in the first display portion and a second image in the second display portion, the second image being independent of the first image.

This invention can provide a digital photograph frame appearing to have plural independent displays although without the costs associated with providing multiple displays. In this way, the digital photograph frame can more closely resemble conventional picture frames, which often have multiple separate framed pictures. In this way, the digital photograph frame can be said to be disguised as a conventional picture frame, and is able to resemble less a conventional digital photograph frame.

The electronic display may have a 16:9 aspect ratio. The cost advantages of such displays can be utilised in the present invention without the scaling and cropping problems that can be experienced with images having a different aspect ratio, for instance 4:3. This advantage can flow from the fact that the dividing member can hide or obscure an area of the electronic display. The electronic display may instead have a 16:10 aspect ratio, although in this case a narrower divider member may be more appropriate.

The apparatus may comprise a reader for interfacing with an external memory device. This can allow digital data, particularly image data, easily to be communicated to the apparatus for display on the electronic display. The apparatus may comprise a memory card reader and/or a USB port.

The apparatus may comprise a remote control receiver module. This can allow control of the apparatus to be achieved by a user without requiring the user to operate physical controls on the apparatus. It can allow the apparatus to be provided without physical controls, or with a reduced number of physical controls.

The apparatus may comprise a connection to a source of electrical power.

The apparatus may comprise a module for connecting the apparatus to an external network. The module may allow the apparatus to be connected directly to a telephone network, for instance.

The frame member may include four surround members, the frame member being secured adjacent the electronic display so that the surround members provide a surround to four edges of the electronic display. This can provide a frame that completely surrounds a square or rectangular electronic display, with the display being divided by the divider member.

### BRIEF DESCRIPTION OF THE DRAWINGS

Embodiments of the present invention will now be described, by way of example only, with reference to the accompanying drawings in which:

FIG. 1 is a perspective view of a digital photograph frame in accordance with the present invention;

FIG. 2 is schematic illustration of the FIG. 1 digital photograph frame in an exploded view; and

FIG. 3 is a schematic diagram illustrating components of the FIGS. 1 and 2 digital photograph frame and their interconnection.

### DETAILED DESCRIPTION OF THE EMBODIMENTS

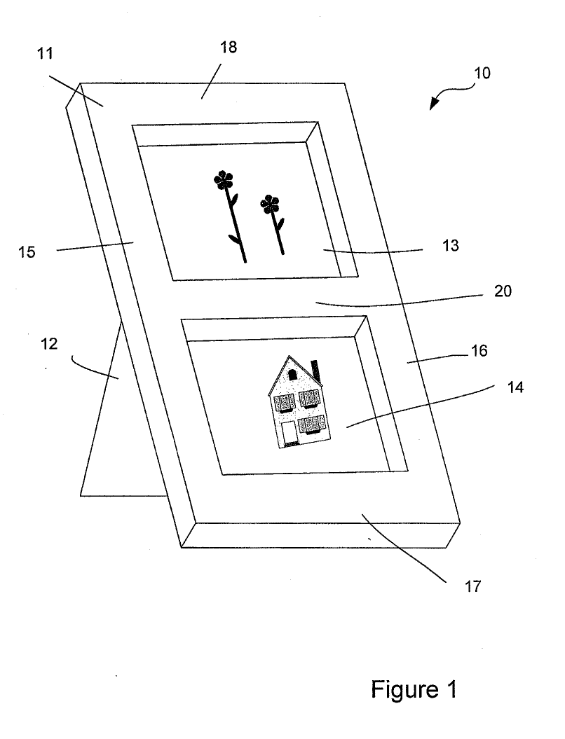

A digital photograph frame 10 in accordance with the presence invention is illustrated in FIG. 1. The digital photograph frame 10 comprises generally a frame member 11, a stand member 12 and first and second picture areas 13, 14. In the first picture area 13, the digital photograph frame 10 displays a digital image representing some flowers, and in the second picture area 14 is displayed a digital image representing a house.

The frame member 11 includes a perimeter formed by a left vertical frame member 15, a right vertical frame member 16, a bottom horizontal frame member 17 and a top horizontal frame member 18. The left vertical frame member 15 is connected to the bottom horizontal frame member 17 at its lower end, and is connected to the top horizontal frame member 18 at its upper end. Similarly, the right vertical frame member 16 is connected to the bottom horizontal frame member 17 at its bottom end and to the top horizontal frame member 18 at its top end.

Connected from a point half way along the left vertical frame member 15 to a point half way along the right vertical frame member 16 is a frame divider member 20. The frame divider member 20 separates the first picture area 13 from the second picture area 14. The length of the frame divider member 20 is equal to the lengths of the bottom and top horizontal frame members 17, 18. The frame divider member 20, the bottom horizontal frame member 17 and the top horizontal frame member 18 extend parallel to one another, and each is perpendicular to the left and right vertical frame members 15, 16.

In this embodiment, the widths of the left and right horizontal frame members 15, 16, the bottom and top horizontal frame members 17, 18 and the frame divider member 20 are approximately equal. Furthermore, the widths of these members are substantially uniform for their entire length. However, in other embodiments (not shown) the relevant dimensions of these members 15-18, 20 may vary. Furthermore, the frame members may have different cross-sectional profiles. For instance, instead of being rectangular the cross-sectional profiles of the frame members may be trapezoidal, or may have a curved upper surface. The frame members may have any suitable shape.

In this embodiment, the frame members are formed unitarily from a plastics material. However, the frame members may alternatively be formed separately and subsequently connected together. The frame members may be made of any other suitable material, for instance, metal or wood. The frame member 11 may be painted, or its surface may be treated in some other fashion. Alternatively, the frame member 11 may have an uncoated surface. Advantageously, the surface of the frame member is smooth, so as to facilitate easy cleaning.

The stand member 12 is connected at one end to the reverse side of the digital photograph frame 10. The stand member 12 is hingedly coupled to the frame member 10 such that the other, free end of the stand member 12 may be held some distance from the base of the digital photograph frame 10. In this way, the digital photograph frame 10 may be supported in an upright position by placement of the free end of the stand member 12 and the base of the digital photograph frame 10 on a surface, for instance a table or shelf.

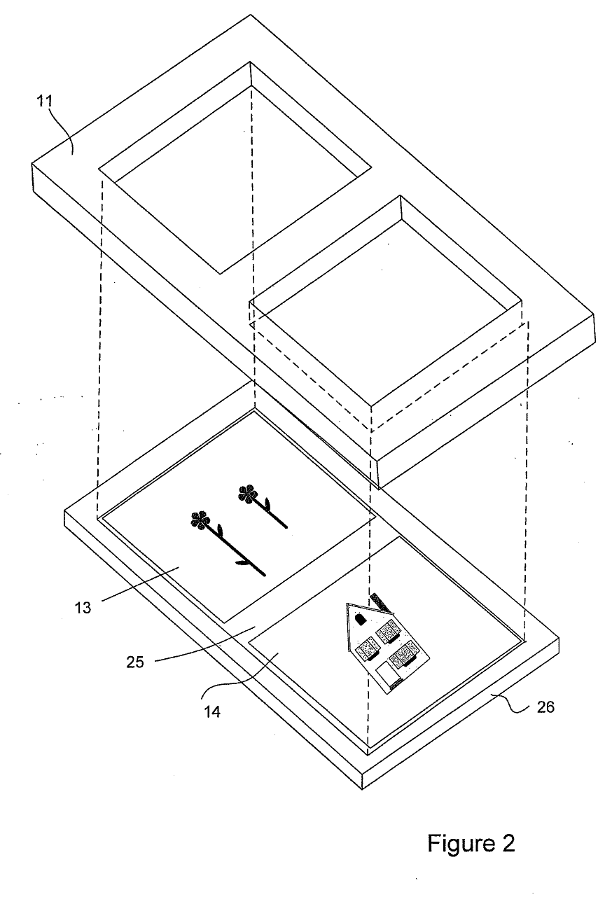

Referring now to FIG. 2, the frame member 11 is shown separated from an electronic display 25. The electronic display is in this embodiment a liquid crystal display (LCD). The LCD 25 is supported on a substrate 26. The substrate 26 may incorporate a circuit board (not shown).

The LCD 25 has a length along its longest side of 15.5 cm, and a length along its shortest side of 8.7 cm. The LCD 25 thus is a 7 inch (17.78 cm) display having an aspect ratio of 16:9.

The first picture area 13, that is defined by the left and right vertical frame members 15, 16, the top horizontal frame member 18 and the frame divider member 20, is shown in FIG. 2 as being located at the uppermost end of the LCD 25. As shown in FIG. 2, the top, left and right edges of the first picture area 13 are close to the edges of the LCD 25. The second picture area 14, which is defined by the left and right vertical frame members 15, 16, the bottom horizontal frame member 17 and the frame divider member 20, is shown located at the bottommost part of the LCD 25. As shown in FIG. 2, the left, right and lower edges of the second picture area 14 are located close to the corresponding edges of the LCD 25.

The bottommost edge of the first picture area 13 is separated from the uppermost edge of the second picture area 14 by a distance that is equal to the width of the frame divider member 20.

In this embodiment, the width of the frame divider member 20, and thus the separation between the first and second picture area 13, 14, is 2.5 cm. The longest dimension of each of the first and second picture areas 13, 14 is 8.50 cm, and the shortest dimension of each of the first and second picture areas 13, 14 is 6.38 cm. Also, the distance between the left and right sides of each of the first and second picture areas and the corresponding edge of the LCD 25 is 1.2 mm. The distance between the top of the first picture area 13 and the top edge of the LCD 25 is 1.2 mm. The distance between the bottom edge of the second picture area 14 and the bottom edge of the LCD 25 is 1.2 mm.

Consequently, each of the first and second picture areas 13, 14 has an aspect ratio of 4:3. Additionally, a distance slightly greater than 1 mm is provided between the edge of each of the first and second picture areas 13, 14 and the edge of the LCD 25. This allows some misalignment between the frame member 11 and the LCD 25 without any part of the substrate 26 being visible within the first and second picture areas 13, 14.

Although not visible in the Figures, the substrate 26 is secured to the frame member 11 so as to prevent movement therebetween. Once assembled, a user is unable to remove the frame member 11 from the digital photograph frame. This helps to ensure that the first and second picture areas 13, 14 remain aligned with the LCD 25.

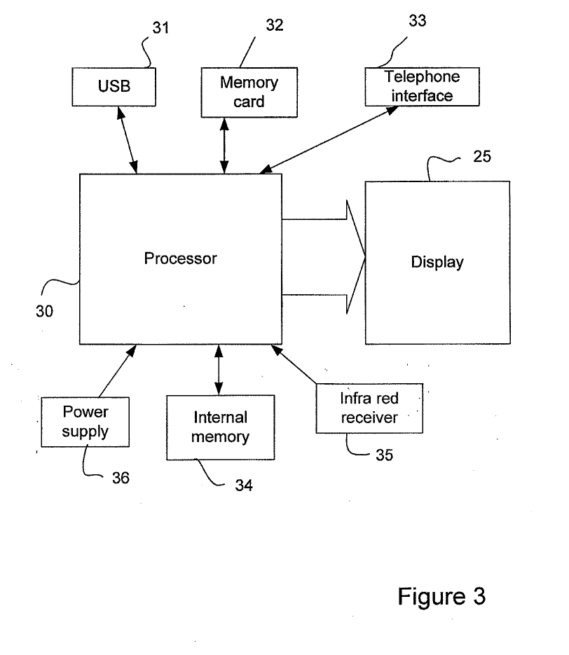

Components of the digital photograph frame 10 are illustrated in FIG. 3. The LCD display 25 is shown to be connected to a processor 13. The processor is in two-way communication with a USB connector 31, a memory card module 32, a telephone interface 33 and an internal memory 34. The processor 30 also is connected to receive signals from an infra-red receiver 35. The processor 30 and all of the other components of the digital photograph frame 10 shown in FIG. 3 are provided with electrical power by a power supply connector 36.

The processor 30 operates under control of software that is stored in non-volatile memory within the digital photograph frame 10. The internal memory 34, if present, may serve as this memory. Alternatively, a separate memory (not shown) may be used for this purpose.

The power supply connector 36 may be connectable to a source of mains electricity (not shown). Alternatively, the power supply connector 36 may be connectable to a mains transformer, such that the digital photograph frame 10 receives a DC power supply derived from a mains power supply. Alternatively, the power supply connector 36 may be a connection to one or more batteries. In this connection, the digital photograph frame 10 may include a battery compartment for accommodating such batteries.

The internal memory 34 is optional. If present, it may be constituted by a flash memory, or a non-volatile memory. The capacity of the internal memory 34 may take any suitable value. For instance, the capacity may be 128 MB, 256 MB, 512 MB, 1 GB or a higher value. A function of the internal memory 34 is to store image files locally on the digital photograph frame 10. In this way, the digital photograph frame 10 can display images even in the absence of an external source of image data.

The USB connector 31 is connectable to external USB devices. In this way, the digital photograph frame can connect with a USB flash memory drive, a USB hard disk storage drive or other external storage. The processor 30 may be arranged to retrieve image data from a device connected to the USB connector 31 in any suitable way.

The memory card module 32 is able to receive external memory cards (not shown). The memory card module 32 may take any suitable form. For instance, the memory card module 32 may be an SD (secure digital) memory card reader. The processor 30 may control the reading and writing of data between a memory card inserted into the memory card module 32 and the internal memory 34 in any suitable way.

The telephone interface 33 is connectable to a telephone network. In this way, data can be communicated between the digital photograph frame 10 and a network-connected device that is coupled to the telephone interface 33, so as to communicate image between the internal memory 34 and the external device.

Telephone network related information, such as caller ID information, can be displayed when a call is received. An image associated with a caller ID (as set by a user in advance) may be displayed with the caller ID. This can allow a user easily to see the identity of a person calling. The image may alternatively be displayed without the caller ID information. This function is optional.

Image data may be communicated between the internal memory 34 and devices connected externally to any of the USB connector 31, the memory card module 32 and the telephone interface 33 in any suitable manner.

The infra-red receiver 35 is operable to translate received infra-red signals into control signals, which are received by the processor 30. In this way, a user can control the digital photograph frame 10 using an infra-red remote control device (not shown). The functions of the digital photograph frame 10 that can be operated by the remote control device may be of any suitable type.

The processor 30 is operable to provide data to the display 24 such as to cause images dependent on images stored in the internal memory 34 or received via any of the USB connector 31, the memory card module 32, and the telephone interface 33 to be displayed so as to be visible by the user. In particular, the processor is configured to control the display 25 to display two different images simultaneously.

The processor 30 is configured to control a first image to be displayed on an uppermost half of the LCD 25, and the second image to be displayed on a lowermost half of the LCD 25. In this way, a different image is displayed in the part of the LCD that incorporates the first picture area 13. The two images are independent of one another. The two different images may be received from the same one of the possible sources of images, namely the internal memory 34, the USB connector 31, the memory card module 32 and the telephone interface 33, or they may be sourced from different ones of these image sources. Additionally, the images displayed on each of the picture areas 13, 14 is controllable by the user, for instance, through the infra-red receiver 35. In particular, a user may control the additional photograph frame to display two different still images in the different picture areas 13, 14. Alternatively, the user may control the digital photograph frame 10 to provide additional still image in one of the first and second picture areas 13, 14 and to provide a slide show of different images in the other one of the picture areas 13, 14. Alternatively, a user may control the digital photograph frame so as to provide a still image or a slideshow of images in one of the picture areas 13, 14 and to provide a clock and/or calendar display in the other one of the picture areas 13, 14.

In an alternative embodiment (not shown) the digital photograph frame 10 is provided with one or more electrical switches, through which a user may input commands into the digital photograph frame 10.

The processor 13 may be configured to control the LCD 25 to display the image that is visible in the first picture area 13 contiguous with the image that is visible in the second picture area 14. Alternatively, the processor 30 may control the LCD 25 to display the images that are visible in the first and second picture areas 13, 14 separated by an area, co-located with the frame divider member 20, absent of any image. The user's experience is the same in either case.

The components shown in FIG. 3 are mounted on the substrate 26. Advantageously, the components are located on a surface of the substrate 26 opposite to the LCD 25 and are protected by a housing member (not shown). In this case, apertures in the housing member allow access of USB devices into the UBS connector 31, access of memory cards into the memory card module 32, and access of a telephone cable into the telephone interface 33. Also, a sensor forming part of the infra red receiver 35 is located on a front or side face of the digital photograph frame 10.

It will be appreciated that the above-described embodiments are purely illustrative, and not limiting on the scope of protection to which we are entitled. For instance, the electronic display 25 need not be an LCD display, but instead could be an organic light emitting diode display, an e-ink display, or some other display technology. Additionally, the digital photograph frame may include more than one frame divider member, dividing the area of the electronic display 25 into more than two distinct picture areas. All alternative embodiments will be conceivable by the persons skilled in the art. The scope of protection is limited only by the appended claims.

What is claimed is:

1. Apparatus comprising:
an electronic display;
a processor coupled to the electronic display and configured by software to divide the electronic display into first and second display portions; and
a frame member including at least two surround members and a divider member,
wherein the frame member is secured adjacent the electronic display so that the surround members provide a surround to at least two opposite edges of the electronic display and such that the first display portion of the electronic display is on an opposite side of the divider member to the second display portion of the electronic display, and wherein the processor is configured by software to control the display to provide a first image in the first display portion and a second image in the second display portion, the second image being independent of the first image.

2. Apparatus as claimed in claim 1, wherein the electronic display has a 16:9 aspect ratio.

3. Apparatus as claimed in claim 1, comprising a reader for interfacing with an external memory device.

4. Apparatus as claimed in claim 3, comprising a memory card reader.

5. Apparatus as claimed in claim 1, comprising a USB port.

6. Apparatus as claimed in claim 1, comprising a remote control receiver module.

7. Apparatus as claimed in claim 1, comprising a connection to a source of electrical power.

8. Apparatus as claimed in claim 1, comprising a module for connection to an external network.

9. Apparatus as claimed in claim 1, wherein the frame member includes four surround members, the frame member being secured adjacent the electronic display so that the surround members provide a surround to four edges of the electronic display.
